(19) United States
(12) Patent Application Publication
(10) Pub. No.: US 2008/0240508 A1
(43) Pub. Date: Oct. 2, 2008

(54) Motion Detection Imaging Device

(75) Inventors: Yoshizumi NAKAO, Daito-shi (JP); Kouichi Kugo, Daito-shi (JP); Takashi Toyoda, Daito-shi (JP); Yasuo Masaki, Daito-shi (JP); Daisuke Miyazaki, Osaka-shi (JP)

Correspondence Address: CROWELL & MORING LLP;INTELLECTUAL PROPERTY GROUP, P.O. BOX 14300, WASHINGTON, DC, 20044-4300, US

(73) Assignees: Funai Electric Co., Ltd., Daito-shi (JP); Osaka City Univeristy, Osaka-shi (JP)

(21) Appl. No.: 12/041,339

(22) Filed: Mar. 3, 2008

(30) Foreign Application Priority Data
Mar. 26, 2007 (JP) 2007-079865

(51) Int. Cl. G06K 9/00; H04N 5/335

(52) U.S. Cl. 382/107; 348/294; 348/E05.091

(57) ABSTRACT

A motion detection imaging device comprises: plural optical lenses for collecting light from an object so as to form plural single-eye images seen from different viewpoints; a solid-state imaging element for capturing the plural single-eye images formed through the plural optical lenses; a rolling shutter for reading out the plural single-eye images from the solid-state imaging element along a read-out direction; and a microprocessor for detecting movement of the object by comparing the plural single-eye images read out from the solid-state imaging element. The plural optical lenses are arranged so that the positions of the plural single-eye images formed on the solid-state imaging element are displaced from each other by a predetermined distance in the read-out direction, and so that the respective single-eye images formed on the solid-state imaging element partially overlap each other in the read-out direction.

### BACKGROUND OF THE INVENTION

1. Field of the Invention

The present invention relates to a motion detection imaging device, and more particularly relates to the detection of movement of a high speed moving object.

2. Description of the Related Art

A motion detection imaging device is known which compares plural images captured by a solid-state imaging element to detect movement of an object (refer to e.g. Japanese Laid-open Patent Publication 2002-171445). Generally a large capacity memory for storing captured images is necessary for comparing these images. However, the motion detection imaging device described in the above-cited Japanese Laid-open Patent Publication 2002-171445 can detect changes between captured images without storing these images, by exposing pixels on each pixel line at separate times and reading charges from the pixels on each pixel line at separate times.

A compound-eye imaging device having a solid-state imaging element is also known (refer to e.g. Japanese Laid-open Patent Publication 2004-32172).

The compound-eye imaging device described in the above-cited Japanese Laid-open Patent Publication 2004-32172 can take plural images captured in different times so as to detect movement of an object, in such a manner that it reads each image information (each single-eye image) from the solid-state imaging element with different timing. Single-eye images formed on the solid-state imaging element are arranged in a matrix of plural rows and plural columns, because optical lenses for forming single-eye images in the compound-eye imaging device are arranged in a matrix of plural rows and plural columns. A time difference between times when two different single-eye images formed on the solid-state imaging element are read out (hereinafter, such a time difference is referred to as “reading time difference”) is larger than or equal to the time required to read out a single-eye image.

Meanwhile, it is hoped to realize a motion detection imaging device which can detect movement of a relatively high speed moving object with a high degree of accuracy in the fields such as a collision avoidance sensor for controlling a robot, a monitor for detecting movement of a relatively high speed moving vehicle including a motorcar, a device for monitoring movement of material carried by a belt conveyer in an assembly line and the like. If such a motion detection imaging device is constructed with the above-described compound-eye imaging device, the reading time difference becomes larger than or equal to the time required to read out a single-eye image as described above. Accordingly, the reading time difference is too large for the motion detection imaging device to detect movement of a high speed moving object with a high degree of accuracy.

The above-described reading time difference can be shotened by improving the frame rate. However, there is a limit to improving the frame rate because of a restriction not only on output speed with which the solid-state imaging element outputs (is read out) image information from the pixels but also on processing speed of the image information. Accordingly, there is a limit to shortening the reading time difference by making the frame rate higher.

### SUMMARY OF THE INVENTION

An object of the present invention is to provide a motion detection imaging device for detecting movement of an object by reading out and comparing plural single-eye images formed on a solid-state imaging element, which can shorten the reading time difference(s), compared to a conventional motion detection imaging device having a compound-eye imaging device, and thereby can detect movement of a high speed moving object with a high degree of accuracy by using simple structure.

According to a first aspect of the present invention, this object is achieved by a motion detection imaging device comprising: plural optical lenses for collecting light from an object so as to form plural single-eye images seen from different viewpoints; a solid-state imaging element for capturing the plural single-eye images formed through the plural optical lenses; a rolling shutter for reading out the plural single-eye images from the solid-state imaging element along a read-out direction; and a motion detection means for detecting movement of the object by comparing the plural single-eye images read out from the solid-state imaging element by the rolling shutter.

The plural optical lenses are arranged so that the positions of the plural single-eye images formed on the solid-state imaging element by the plural optical lenses are displaced from each other by a predetermined distance in the read-out direction, and so that the plural single-eye images formed on the solid-state imaging element partially overlap each other in the read-out direction.

With the above configuration, the positions of the plural single-eye images formed on the solid-state imaging element by the plural optical lenses are displaced from each other in the read-out direction within the range where the plural single-eye images formed on the solid-state imaging element partially overlap each other in the read-out direction. Accordingly, reading time difference(s) between the plural single-eye images can easily be shortened, compared to a conventional motion detection imaging device having a compound-eye imaging device. Thus, this motion detection imaging device can detect movement of a high speed moving object with a high degree of accuracy by using simple structure.

Preferably, the plural optical lenses are three optical lenses arranged along a direction intersecting with the read-out direction.

Preferably, the motion detection means generates velocity vectors on a unit pixel basis by comparing the plural single-eye images read out from the solid-state imaging element so as to detect movement of the object.

More preferably, the motion detection means generates an acceleration vector of the object based on the generated velocity vectors.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is an electrical block diagram of a motion detection imaging device according to a first embodiment of the present invention;

FIG. 2 is a schematic cross-sectional view of a compound-eye imaging device along line W-W′ of FIG. 3 in the motion detection imaging device;

FIG. 3 is a schematic plan view of a solid-state imaging element in the motion detection imaging device on which two single-eye images A and B are formed;

FIG. 4 is a flow chart showing a motion detection process in the motion detection imaging device;

FIGS. 5A, 5B and 5C are diagrams showing an example of the single-eye image A, the single-eye image B, and an image including a velocity vector V created by the motion detection imaging device, respectively;

FIG. 6 is a schematic plan view of a solid-state imaging element on which three single-eye images A, B and C are formed in a motion detection imaging device according to a second embodiment of the present invention;

FIG. 7 is a flow chart showing a motion detection process in the motion detection imaging device; and

FIG. 8 is a diagram showing an example of an acceleration vector Va generated in the motion detection imaging device.

### DESCRIPTION OF THE PREFERRED EMBODIMENTS

Embodiments of the present invention, as best mode for carrying out the invention, will be described hereinafter with reference to the drawings. The present invention relates to a motion detection imaging device. It is to be understood that the embodiments described herein are not intended as limiting, or encompassing the entire scope of, the present invention. Note that like parts are designated by like reference numerals, characters or symbols throughout the drawings.

### First Embodiment

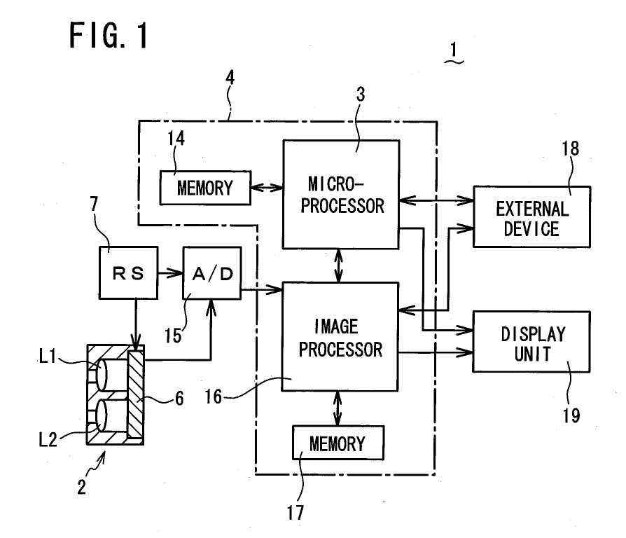

Referring to FIG. 1 to FIG. 8, a motion detection imaging device (imaging device for motion detection) 1 according to a first embodiment of the present invention will be described. As shown in FIG. 1, the motion detection imaging device 1 comprises: a compound-eye imaging device 2 for collecting light from an object so as to capture two single-eye images; and an electronic circuit 4 having a microprocessor 3 (motion detection means) as its main part. The microprocessor 3 detects movement of an object by comparing plural single-eye images.

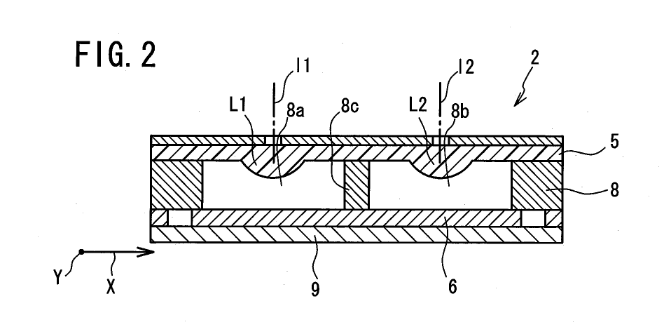

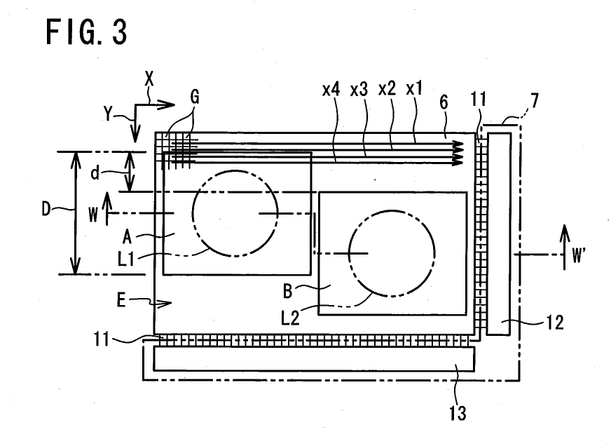

As shown in FIG. 2 and FIG. 3, the compound-eye imaging device 2 comprises: an optical lens array 5 having two optical lenses L1, L2 which have mutually parallel optical axes 11, 12, and which are arranged in the same plane and collect light from an object so as to form two single-eye images seen from different viewpoints; a solid-state imaging element 6 which captures two single-eye images A and B formed through respective optical lenses L1, L2, and which is arranged parallel to the optical lens array 5; and a rolling shutter 7 (RS). The rolling shutter 7 is used for reading out the two single-eye images A and B formed on the solid-state imaging element 6 in the sequence of the single-eye image A and the single-eye image B with tiny time difference when it is released once.

As shown in FIG. 2, the optical lens array 5 is held by a lens holder 8. The lens holder 8 has aperture-stops 8a and 8b for adjusting the amount of light that enters the respective optical lenses L1 and L2. The partition wall member 8c is arranged near the center in the longitudinal direction of the lens holder 8. The partition wall member 8c prevents light from the optical lenses L1 to the solid-state imaging element 6 from interfering with light from the optical lenses L2 to the solid-state imaging element 6.

The solid-state imaging element 6 having a substrate 9 is, for example, a CMOS (Complementary Metal Oxide Semiconductor) image sensor. As shown in FIG. 3, the solid-state imaging element 6 has many unit pixels G arranged in a matrix of rows and columns (X and Y directions). The two single-eye images A and B are formed on the solid-state imaging element 6.

The rolling shutter 7 is mainly composed of a vertical scannning circuit 12 amd a horizontal scannning circuit 13 whose connecting lines 11 to all the unit pixels G on the solid-state imaging element 6 are arranged in a matrix. The rolling shutter 7 reads charges from the respective unit pixels G in the following manner. The vertical scannning circuit 12 and the horizontal scannning circuit 13 outputs a vertical and a horizontal scan pulse at a predetermined timing, respectively. The rolling shutter 7 reads charges from the respective unit pixels G in the first row (line) x1 shown in FIG. 3 along X direction in response to the above-described scan pulses. Then, the rolling shutter 7 reads charges from the respective unit pixels G in the second row (line) x2. The rolling shutter 7 subsequently reads charges from the respective unit pixels G in the third row (line) x3. This sequence of reading charges is repeated until reading of charges from all the unit pixels G in the every row (line) on the solid-state imaging element 6 is completed. Each row (line) along the X direction on the solid-state imaging element 6 is hereafter referred to as “read-out line”. The Y direction is hereafter referred to as “read-out direction” of the rolling shutter 7. In the present embodiment, lengths D of each single-eye image A and B in the Y direction (read-out direction) corresponds to 300 read-out lines.

The optical lenses L1 and L2 are arranged so that the positions of two single-eye images A and B formed on the solid-state imaging element 6 by the lenses L1 and L2 are displaced from each other by a predetermined distance d in the Y direction (read-out direction). The above-described predetermined distance d is equal to one-third of the length D of the single-eye image A in the Y direction (corresponds to 100 read-out lines). Therefore, the single-eye images A and B overlap each other by two-thirds in the Y direction. Note that the predetermined distance d is not necessarily one-third of the length D of the single-eye image A, but may be another length.

According to the compound-eye imaging device 2 having the above-described configuration, when the rolling shutter 7 is released once, the charges from all the unit pixels G on the solid-state imaging element 6 are read line by line in the order of row (line) x1, x2, . . . , and xn along the Y direction so as to be output to the electronic circuit 4 as digital information.

As shown in FIG. 1, the electronic circuit 4 comprises: the above-described microprocessor 3 for controlling the entire operation of the motion detection imaging device 1; a memory 14 which not only stores various kinds of setting data used by the microprocessor 3 but also temporarily stores the comparison result between the single-eye images A and the single-eye images B; an image processor 16 which reads image information based on charges from the compound-eye imaging device 2 through an A/D (Analog-to-Digital) converter 15, and which perfroms image processing such as gamma correction and white balance correction of the image information so as to convert the image information into a form that the microprocessor 3 can easily process it; and a memory 17 which stores a various kinds of data tables used by the image processor 16, and which stores temporarily image data in processing. The microprocessor 3 and the image processor 16 are connected to not only an external device 18 such as a personal computer but also a display unit 19 such as a liquid crystal panel.

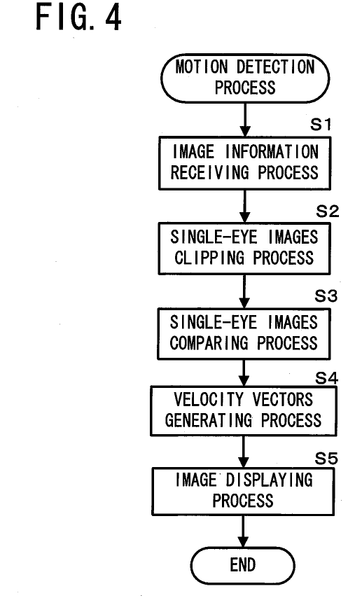

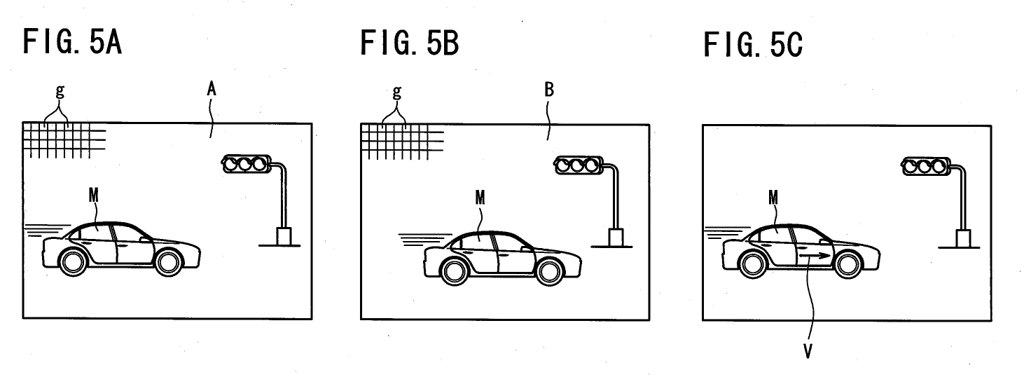

Referring now to the flowchart of FIG. 4, a process is described that is performed by the motion detection imaging device 1 according to the persent embodiment. The microprocessor 3 receives from the image processor 16 the image information which the image processor 16 reads from the compound-eye imaging device 2 and perfroms various corrections (S1). Subsequently, the microprocessor 3 clips the single-eye images A and B from the above-described image information (S2). Concretely speaking, because the image information output from the image processor 16 includes not only the single-eye images A and B but also the image information in the region E shown in FIG. 3, the microprocessor 3 removes the image information in the region E from the image information output from the image processor 16 so as to cut out the single-eye images A and B having a predetermined rectangular shape. FIG. 5A and FIG. 5B show examples of the single-eye images A and B cut out by the microprocessor 3, respectively.

The positions of single-eye images A and B formed on the solid-state imaging element 6 are displaced from each other by 100 read-out lines in the Y direction. Therefore, if the time required to read out one read-out line on the solid-state imaging element 6 is T seconds long, there is 100 T seconds difference between the times when the rolling shutter 7 has finished reading out the single-eye image A and when the rolling shutter 7 has finished reading out the single-eye image B (hereinafter, such a time difference is referred to as “reading time difference between the single-eye images A and B”). Accordingly, the single-eye image B is the single-eye image which is read out 100 T seconds after the single-eye image A has been read out. For example, if the time T is 60 microseconds, the above-described 100 T seconds is 6 milliseconds. The time of 6 milliseconds corresponds to the time required for a motorcar at 60 km/h to go about 10 centimeters. FIG. 5A and FIG. 5B show examples of the single-eye images A and B read out from the solid-state imaging element 6. Even if the time T required to read out one read-out line on the solid-state imaging element 6 is the same, the above-described reading time difference between the single-eye images A and B can be made smaller down to the time T by making the distance d between the positions of the single-eye images A and B shorter than the length corresponding to 100 read-out lines (for example, the length corresponding to one read-out line).

Subsequently, the microprocessor 3 compares the single-eye images A and B on a unit pixel G basis (S3) so as to generate velocity vectors on a unit pixel G basis from the position displacements between corresponding unit pixels G on the single-eye images A and B (S4). For example, the microprocessor 3 generates right velocity vectors based on each unit pixel G in a partial image of a motorcar M shown in FIGS. 5A and 5B. The microprocessor 3 merges these velocity vectors into a single velocity vector V. The microprocessor 3 creates an image shown in FIG. 5C by superimposing the single velocity vector V onto the single-eye image A so as to display the created image on the display unit 19 (S5).

As described in the foregoing, the motion detection imaging device 1 of the present embodiment can easily shorten (make smaller) the reading time difference between the single-eye images A and B, compared to a conventional motion detection imaging device having a compound-eye imaging device. Accordingly, the motion detection imaging device 1 can easily detect movement of a high speed moving object with a high degree of accuracy based on the position displacements between corresponding unit pixels G on the single-eye images A and B. Furthermore, because the motion detection imaging device 1 can display on the display unit 19 the image created by superimposing the velocity vector V representing movement of an object onto an image of an object (the single-eye image A), a user can easily recognize the speed and direction of a moving object.

Note that, at the step S3, the microprocessor 3 may compare the single-eye images A and B on a unit pixel group basis instead of on a unit pixel G basis. In this case, the unit pixel group consists of, for example, neighboring plural unit pixels. Furthermore, the velocity vector V generated by the microprocessor 3 may be output to the external device 18 such as a personal computer as information representing movement of an object so as to be analyzed by the external device 18.

### Second Embodiment

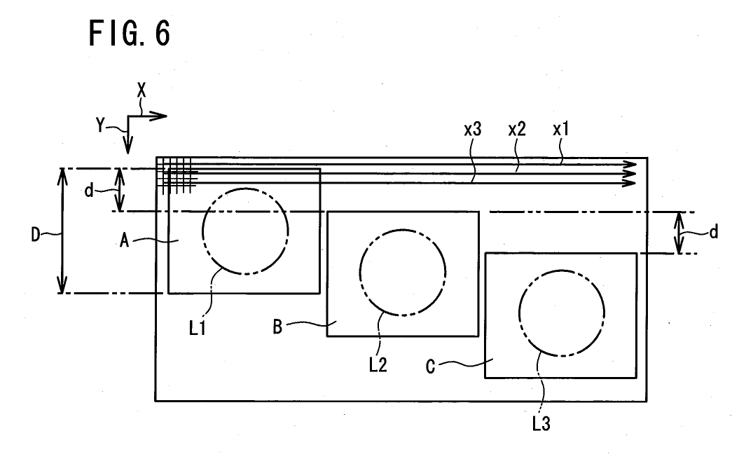

Referring to FIG. 6 to FIG. 8, a motion detection imaging device 1 according to a second embodiment of the present invention will be described. The motion detection imaging device 1 of the second embodiment is similar to that of the first embodiment, except that three optical lenses L1, L2 and L3 composing the optical lens array 5 in the compound-eye imaging device 2 are arranged along the X direction as shown in FIG. 6, and that the microprocessor 3 detects acceleration of a moving objest based on three single-eye images A, B and C which are formed by the optical lenses L1, L2 and L3.

As shown in FIG. 6, the optical lenses L1, L2 and L3 in the compound-eye imaging device 2 are arranged so that the positions of single-eye images A and B formed on the solid-state imaging element 6 by the lenses L1 and L2 are displaced from each other by a predetermined distance d in the Y direction, and so that the positions of single-eye images B and C formed by the lenses L2 and L3 are similarly displaced from each other by the distance d in the Y direction. The above-described distance d is equal to one-third of the length D of one single-eye image in the Y direction.

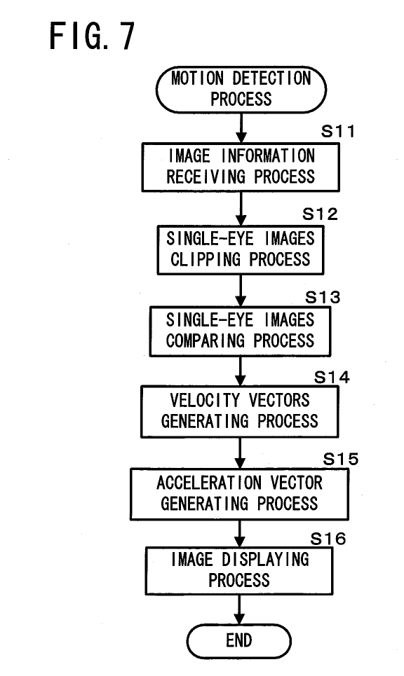

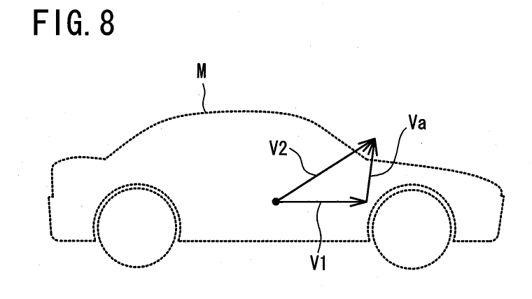

Referring now to the flowchart of FIG. 7, a process is described that is performed by the motion detection imaging device 1 according to the second embodiment. Because an image information receiving process at a step S11, a single-eye images clipping process at a step S12, a single-eye images comparing process at a step S13, and a velocity vectors generating process at a step S14 are basically similar to those at the step S1, S2, S3, and S4 in FIG. 4, respectively, the datailed description is omitted here. The microprocessor 3 in the second embodiment compares the single-eye images A and B on a unit pixel G basis so as to generate velocity vectors on a unit pixel G basis from the comparison result (specifically, the position displacements between corresponding unit pixels G on the single-eye images A and B). Subsequently, in the step S14, the microprocessor 3 merges these velocity vectors into a single velocity vector V2 shown in FIG. 8. In other words, the microprocessor 3 generates the velocity vector V1. Similarly, the microprocessor 3 compares the single-eye images B and C on a unit pixel G basis so as to generate velocity vectors on a unit pixel G basis from the comparison result. Subsequently, the microprocessor 3 merges these velocity vectors into a single velocity vector V2 shown in FIG. 8. In other words, the microprocessor 3 generates the velocity vector V2. FIG. 8 shows an example of the velocity vector V1 and V2 generated by the microprocessor 3 in the case where a moving object is a motorcar M.

Next, the microprocessor 3 generates an acceleration vector Va shown in FIG. 8 based on the above-described velocity vector V1 and V2 (S15). Subsequently, the microprocessor 3 superimposes the acceleration vector Va onto the single-eye image A so as to display the image including the acceleration vector Va shown in FIG. 8 on the display unit 19 (S16). In the example shown in FIG. 8, the acceleration vector Va extends obliquely upward and forward from the motorcar M. Thus, it is determined that the motorcar M reaches an assending slope such as a climbing lane, and that the motorcar M is accelerating upward.

As described in the foregoing, the motion detection imaging device 1 according to the present embodiment can not only easily detect movement of a high speed moving object based on the position displacements between corresponding unit pixels G on the single-eye images A, B and C, but also generate the acceleration vector Va so as to display the image including the acceleration vector Va on the display unit 19. Accordingly, a user can easily recognize the direction in which the objects moves, the change in movement of an object, and the like, thereby a user can predict movement of the object.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

This application is based on Japanese patent application 2007-79865 filed Mar. 26, 2007, the content of which is hereby incorporated by reference.

What is claimed is:

1. A motion detection imaging device comprising:
plural optical lenses for collecting light from an object so as to form plural single-eye images seen from different viewpoints;
a solid-state imaging element for capturing the plural single-eye images formed through the plural optical lenses;
a rolling shutter for reading out the plural single-eye images from the solid-state imaging element along a read-out direction; and
a motion detection means for detecting movement of the object by comparing the plural single-eye images read out from the solid-state imaging element by the rolling shutter,
wherein the plural optical lenses are arranged so that the positions of the plural single-eye images formed on the solid-state imaging element by the plural optical lenses are displaced from each other by a predetermined distance in the read-out direction, and so that the respective single-eye images formed on the solid-state imaging element partially overlap each other in the read-out direction.

2. The motion detection imaging device according to claim 1, wherein the plural optical lenses are three optical lenses arranged along a direction intersecting with the read-out direction.

3. The motion detection imaging device according to claim 2, wherein the motion detection means generates velocity vectors on a unit pixel basis by comparing the plural single-eye images read out from the solid-state imaging element so as to detect movement of the object.

4. The motion detection imaging device according to claim 3, wherein the motion detection means generates an acceleration vector of the object based on the generated velocity vectors.

5. The motion detection imaging device according to claim 1, wherein the motion detection means generates velocity vectors on a unit pixel basis by comparing the plural single-eye images read out from the solid-state imaging element so as to detect movement of the object.
